(19) United States
(12) Patent Application Publication
(10) Pub. No.: US 2014/0025531 A1
(43) Pub. Date: Jan. 23, 2014

(54) SYSTEMS AND METHODS FOR SHOPPING IN AN ELECTRONIC COMMERCE ENVIRONMENT WITH SOCIAL NETWORKING CONNECTIONS

(71) Applicant: Kothai Nachiappan, Bangalore (IN)

(72) Inventor: Kothai Nachiappan, Bangalore (IN)

(73) Assignee: WAL-MART STORES, INC., Bentonville, AR (US)

(21) Appl. No.: 13/554,733

(22) Filed: Jul. 20, 2012

(51) Int. Cl. G06Q 30/06

(52) U.S. Cl. CPC G06Q 30/0631
USPC 705/26.7

(57) ABSTRACT

A computer-implemented method for shopping in an electronic commerce environment via a data communication network includes identifying a first user who is interacting with the electronic commerce environment via a browser, selecting items for sale in the electronic commerce environment based on a browsing history of a second user associated with the first user via a social network connection, and displaying a representation of the selected items to the first user via the browser. The browsing history of the second user includes items viewed and/or purchased by the second user. The method may include updating the selection of items to include items relevant to content being displayed to the first user via the browser. The relevance may be based at least in part on information describing a function, a characteristic and/or a price of the items with respect to the content.

### BACKGROUND

1. Field of Invention

Embodiments of the invention relate generally to electronic commerce.

2. Description of Related Art

Increasingly, people are incorporating online-based technologies into their lives. For example, electronic commerce, or e-commerce, has been a popular channel for buying and selling products and services through the Internet. Many merchants of all sizes now maintain an online presence at websites where consumers can shop for and purchase a wide variety of products and services using nearly any Internet-connected device. A significant number of people also use the Internet for social networking through online services such as Facebook® provided by Facebook Inc. of Menlo Park, Calif., Twitter® provided by Twitter, Inc. of San Francisco, Calif., and Orkut® provided by Google Inc. of Mountain View, Calif. The proliferation of online social networking services has enabled people to become increasing aware of each other's interests and activities.

### SUMMARY

Various embodiments are directed to systems and methods for shopping in an e-commerce environment. E-commerce refers to technologies that facilitate the buying and selling of products and services using electronic systems, such as computers connected together over the Internet or other data communication networks. In one exemplary embodiment, an e-commerce website is configured to enable users to leverage social networking connections existing outside of the e-commerce environment (e.g., connections between people who are friends at a social networking website) for sharing their individual browsing and/or purchasing activities in the e-commerce environment with each other. For example, when a user visits the e-commerce website, the website may display the browsing history of one or more of the user's friends, with whom the user has a social network connection.

In one embodiment, a computer-implemented method for shopping in an electronic commerce environment via a data communication network includes identifying a first user who is interacting with the electronic commerce environment via a browser, selecting items for sale in the electronic commerce environment based on a browsing history of a second user associated with the first user via a social network connection, and displaying a representation of the selected items to the first user via the browser. The browsing history of the second user includes items viewed and/or purchased by the second user. In some embodiments, the method may include updating the selection of items to include items relevant to content being displayed to the first user via the browser. The relevance may be based at least in part on information describing a function, a characteristic and/or a price of the items with respect to the content.

In one embodiment, a system for shopping in an electronic commerce environment includes a server having a processor and a memory coupled together. The memory includes instructions that when executed by the processor cause the server to identify a first user who is interacting with the electronic commerce environment via a browser, select items for sale in the electronic commerce environment based on a browsing history of a second user associated with the first user via a social network connection, and display a representation of the selected items to the first user via the browser. The browsing history of the second user includes items viewed and/or purchased by the second user. In some embodiments, the memory may include instructions that when executed by the processor cause the server to update the selection of items to include items relevant to content being displayed to the first user via the browser. The relevance may be based at least in part on information describing a function, a characteristic and/or a price of the items with respect to the content.

In one embodiment, a non-transitory computer-readable medium has stored thereon computer-executable instructions that when executed by a computer cause the computer to identify a first user who is interacting with the electronic commerce environment via a browser, select items for sale in the electronic commerce environment based on a browsing history of a second user associated with the first user via a social network connection, and display a representation of the selected items to the first user via the browser. The browsing history of the second user includes items viewed and/or purchased by the second user.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a block diagram representing one example of relationships between users, and interactions between users and an e-commerce platform, in accordance with one embodiment;

FIG. 2 is a more detailed block diagram showing one example of the e-commerce platform of FIG. 1, in accordance with one embodiment;

FIG. 3 is a block diagram of one example of a storage structure for data that may be used in conjunction with the e-commerce platform of FIG. 1, in accordance with one embodiment;

FIG. 4A is a representation of one example of a graphical user interface for displaying an item list as used in conjunction with the e-commerce platform of FIG. 1;

FIG. 4B is a representation of another example of a graphical user interface for displaying the item list as used in conjunction with the e-commerce platform of FIG. 1;

FIGS. 5A-5C are representations of exemplary graphical user interfaces for establishing and managing connections and privacy settings as used in conjunction with the e-commerce platform of FIG. 1, in accordance with at least one embodiment;

FIG. 6 is a flow diagram showing one example of a method for shopping in an e-commerce environment, in accordance with one embodiment;

FIG. 7 is a block diagram showing an exemplary computing device that may be used to perform any of the methods provided by exemplary embodiments; and

FIG. 8 is a diagram showing an exemplary network environment suitable for a distributed implementation of exemplary embodiments.

### DETAILED DESCRIPTION

As discussed above, online- or web-based technologies have enabled people to use the Internet for shopping as well as for maintaining social connections with one another. However, some conventional platforms for performing discrete functions, e.g., commerce or social networking, are application-specific and not integrated with platforms that perform other functions. For example, an e-commerce website is typically designed to facilitate sales of products and services, but does not support social networking. Similarly, a social networking website is typically designed to facilitate the creation and maintenance of social relationships, but does not support e-commerce.

According to various embodiments, it is appreciated that many consumers are often influenced by the purchasing decisions of other people, particularly people that they know, such as friends and family. Therefore it would be advantageous for people to utilize their social network connections for acquiring information about others' online shopping activities. For example, in one embodiment, an e-commerce website is configured to display the browsing history of a user's friends each time the user visits the website. Since people are often influenced by the interests and activities of their friends, the e-commerce website user may be motivated to purchase, or at least consider purchasing, the same products browsed or purchased by their friends if such information is dynamically displayed to them as they are interacting with the website.

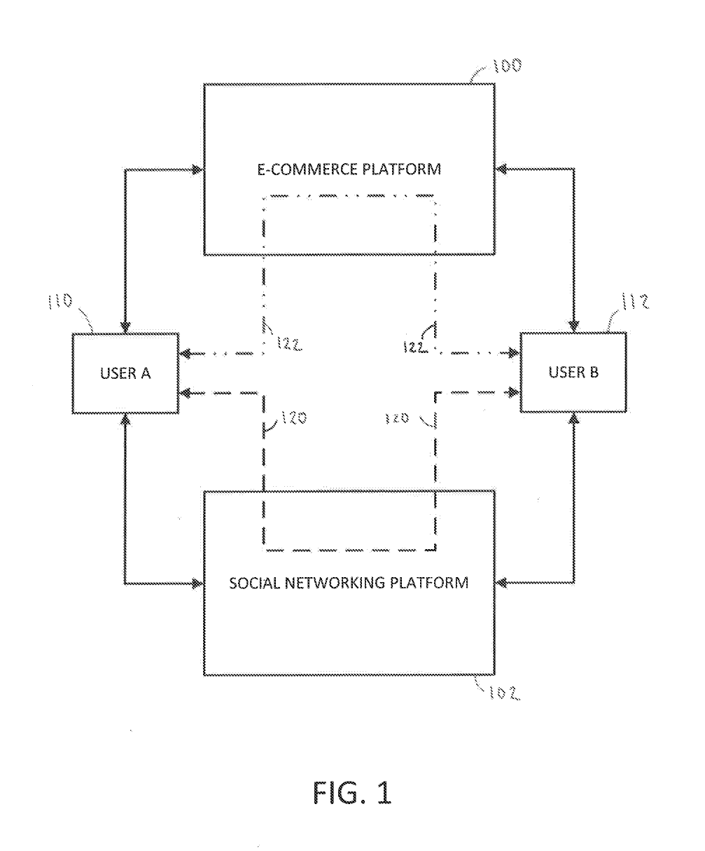

As an introduction, FIG. 1 illustrates one example of user-to-user relationships and user-to-platform interactions that may exist in the contexts of an e-commerce platform 100 and a social networking platform 102, according to one embodiment. The e-commerce platform 100 can include any computer system or group of systems that provide e-commerce services to various users over a data communication network, such as the Internet. For example, the e-commerce platform 100 may host one or more e-commerce websites operated by a merchant, and/or support other e-commerce applications (e.g., customized applications for mobile devices and/or customized PC-based applications). In general, the e-commerce websites and applications permit users of computer-based devices to browse and/or purchase items from the merchant via the e-commerce platform 100. The social networking platform 102 can include any computer system or group of systems that provide social networking services to various users over a data communication network, and may be separate and distinct from the e-commerce platform 100. In one embodiment, at least some of the users of the e-commerce platform 100 are also users of the social networking platform 102. In this example, for simplicity, two users User A 110 and User B 112 are shown in, and described with respect to, FIG. 1, although it will be understood that more than two users can be supported by the e-commerce platform 100 and the social networking platform 102.

Each user may independently interact with the e-commerce platform 100 and the social networking platform 102. For example, User A 110 and User B 112 may each interact with a website deployed on the e-commerce platform 100 by a merchant while shopping for products or services offered by the merchant. The user may use any application that is adapted for the user's computing platform (e.g., PC, mobile device, tablet device, etc.) and configured to interact with the e-commerce platform 100 through the data communication network (e.g., the Internet), such as a conventional web browser (e.g., Internet Explorer® available from Microsoft Corporation of Redmond, Wash.) or a customized application (e.g., Walmart® Mobile App developed by Wal-Mart Stores, Inc., of Bentonville, Ark., which is the assignee of the present application). Similarly, User A 110 and User B 112 may each interact with a website deployed on the social networking platform 102 while engaging in social networking activities facilitated by the website's service provider (e.g., Facebook®, Twitter®, Orkut®, etc.) using similar devices and applications.

At least one connection, or relationship, can be defined between User A 110 and User B 112. As used herein, the terms connection and social network connection refer to a virtual association or relationship between two or more users in the context of the e-commerce platform 100 and the social networking platform 102. Such associations may exist within or as part of, for example, categorized groups of users, friend or user-to-user relationships, and/or friend or user recommendations. It will be understood that the foregoing definition is intended to be non-limiting, and may be extended or modified to include additional forms of associations, such as electronic mailing, contact, membership or subscriber lists, public records, or other data obtained from various sources (e.g., search engines). Users having connections may be alternatively referred to as friends or buddies, since such connections may exist between users who are friends in real life, although not necessarily so. In one example, a first connection 120 may be defined between User A 110 and User B 112 through the social networking platform 102. Thus, User A 110 and User B 112 may refer to each other as friends within the context of the social networking platform 102, using the first connection 120. In this context, the first connection 120 facilitates the exchange of data and other information between User A 110 and User B 112 via the social networking platform 102.

According to one embodiment, while the first connection 120 may exist within the context of the social networking platform 102, User A 110 and User B 112 may also interact within the context of other platforms, such as the e-commerce platform 100, where the first connection 120 may not exist. This situation may occur, for example, if the e-commerce platform 100 and the social networking platform 102 are operated by different, unrelated entities. In the absence of any connection between User A 110 and User B 112 in the e-commerce platform 100 context, it is difficult, if not impossible, for User A and User B to exchange information via the e-commerce platform 100. Therefore, in this embodiment, the e-commerce platform 100 is configured to enable the establishment of a second connection 122 between User A 110 and User B 112. For example, either or both User A 110 and User B 112 may establish the second connection 122 by importing or copying the first connection 120 into the context of the e-commerce platform 100, or by inviting (e.g., via the first connection, e-mail, instant messaging, etc.), User A and/or User B to establish the second connection through acceptance of the invitation. As described below in further detail, in one embodiment, the website on the e-commerce platform 100 is configured to facilitate (e.g., using a user interface) the importation of social network connections existing outside of the e-commerce context, and/or the generation of invitations to other users to establish connections within the e-commerce context.

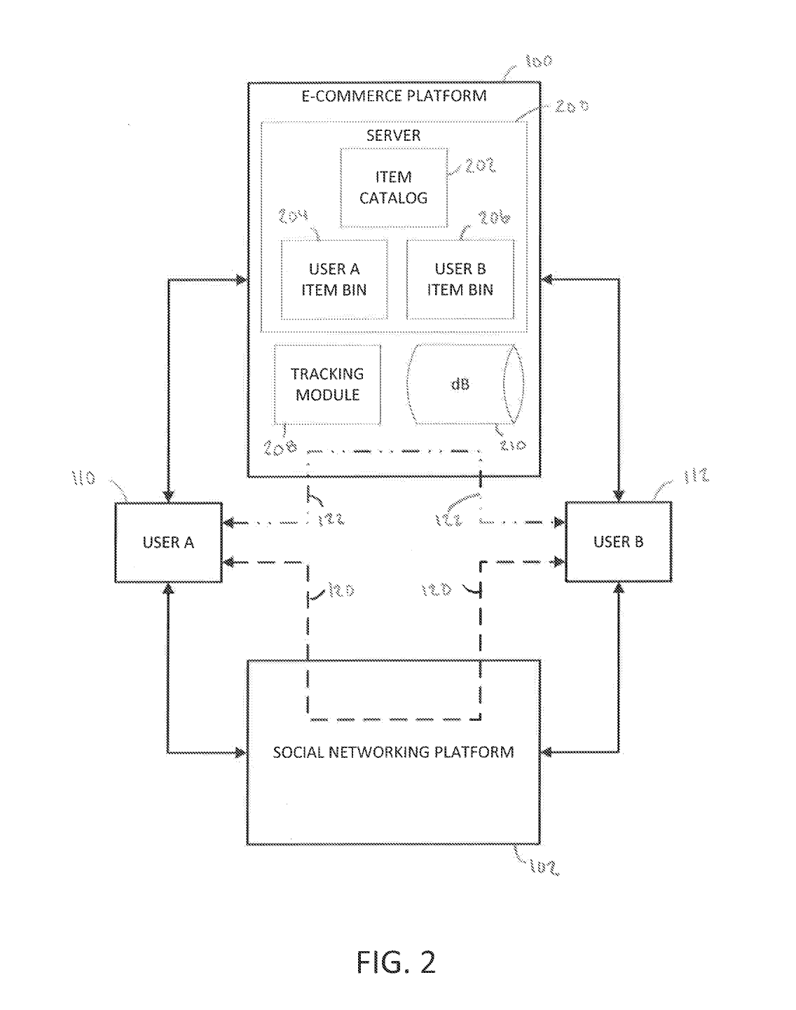

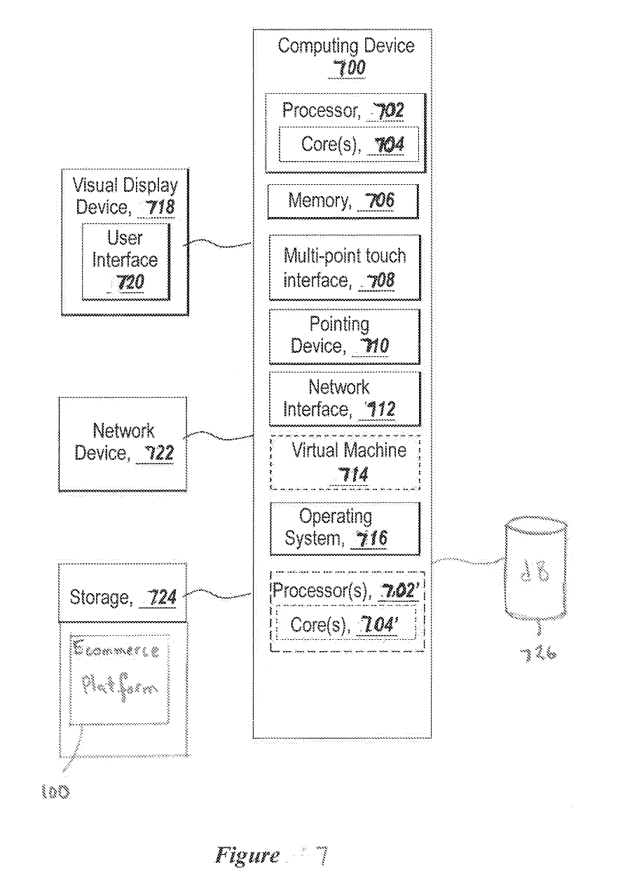

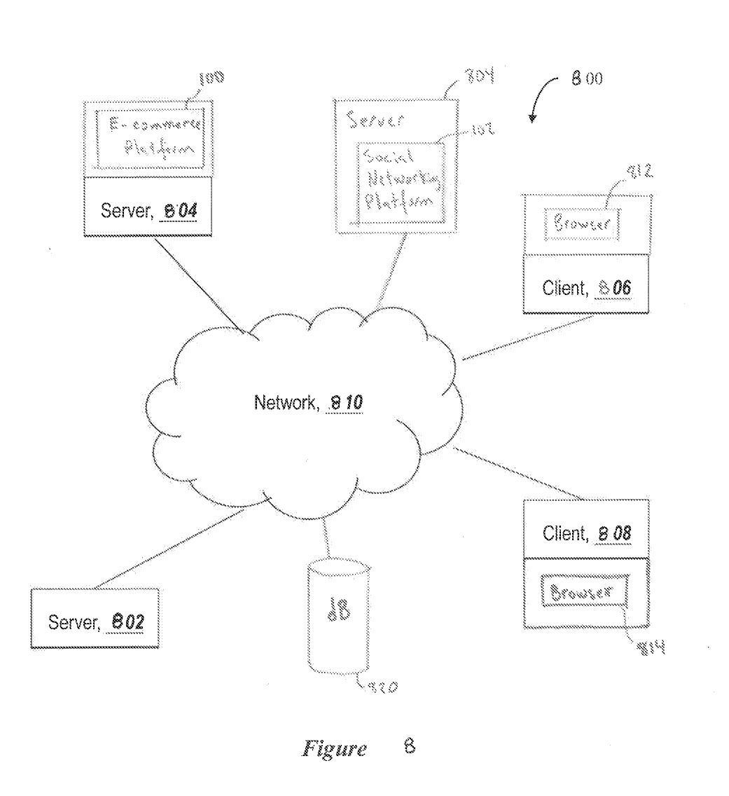

FIG. 2 is a more detailed diagram of the e-commerce platform 100 shown in FIG. 1, according to one embodiment. The e-commerce platform 100 includes a server 200 configured to maintain a catalog of items 202 for sale and a browsing/purchasing history associated with each user who interacts with the e-commerce platform 100. One example of an e-commerce server is depicted and discussed in connection with FIGS. 7 and 8, below. The item catalog 202 is a repository (e.g., in a database) for information about items that can be browsed and/or purchased by users interacting with the e-commerce platform 100, including product names, descriptions, photographs, prices, specifications, and other related information, such as search keywords or tags associated with each item to facilitate searching and categorizing the products. At least a portion of the browsing/purchasing history of any user may be included in a virtual container or list referred to herein as User A item bin 204 and User B item bin 206. The item bins 204 and 206 are also repositories (e.g., in the same or a different database) for information about the items that are specific to each user, as will be described below.

The server 200, in one embodiment, is further configured to operate in conjunction with the computer-based devices of each user in various ways, such as by hosting the e-commerce website. For example, as User A 110 or User B 112 interacts with the e-commerce website, the server 200 may display representations of the items from the catalog 202 to User A or User B via a browser (not shown) on the user's computer-based device. The representations may include images and/or descriptions of the items, as well as prices and other relevant information. The representations may further include embedded hyperlinks that, when selected by the user within the browser, cause the server 200 to perform various actions, such as displaying additional information about the item, additional item representations, adding the item to an electronic shopping cart, and/or purchasing or ordering the item.

In one embodiment, as each user interacts with the e-commerce website, the server 200 tracks, using a tracking module 208, the activity of the user on the website and stores information about this activity in a database 210. The activity includes the browsing and/or purchasing history of the user on the website. For example, if User A 110 browses an Acme MP3 Player, information about the MP3 player may be stored by the server 200 in the database 210, including identifying information such as the item name, model number, universal product code (UPC) number of the item, and/or an item number assigned to the item by the merchant, as well as information associated with User A (e.g., User A's username or account number). Further, the server 200 may store, in the database 210, information relating to User A's activity with respect to the item, for example, whether User A purchased or simply viewed the item online, and the time and date when User A viewed or purchased the item.

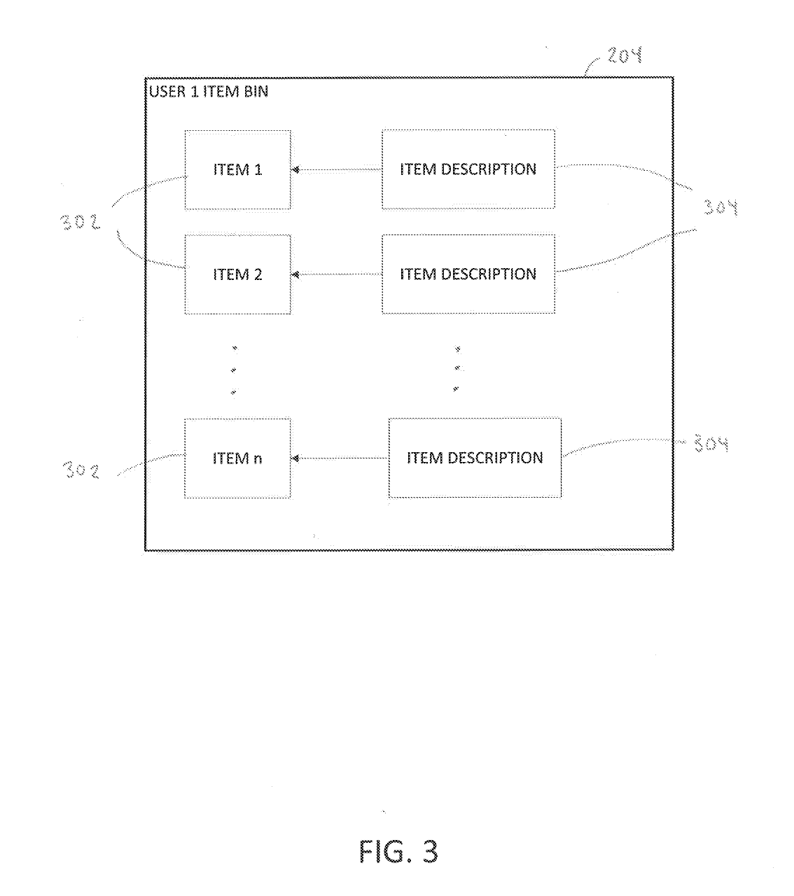

As discussed above, in one embodiment the e-commerce platform 100 enables User A 110 to establish a connection (i.e., the second connection 122) to User B 112, or vice versa. Once the second connection 122 is established, the server 200 generates, for each user, the item bins 204 and 206. FIG. 3 is a block diagram representation of one user item bin, such as the User 1 item bin 204 of FIG. 2, according to one embodiment. Each item bin 204, 206 includes a list, table or file of items 302 that have previously been viewed and/or purchased by another user with whom the user has a connection, i.e., the user's buddy. For example, the User A item bin 204 may contain a list of items browsed/purchased by User B, and the User B item bin 206 may contain a list of items browsed/purchased by User A, since User A is connected to User B within the context of the e-commerce platform 100. It will be understood that item bins can be generated for any number of users. Each item bin may be personalized for a particular user, for example, the User A item bin 204 may contain at least a portion of the browsing/purchasing history of User B and/or any other users with whom User A is connected to within the context of the e-commerce platform 100. Further, the item bin may contain information 304 about each item, such as described above (e.g., item description, etc.). Alternatively, some item information may be stored elsewhere and linked to the item bin.

In one embodiment, the User A item bin 204 and/or the User B item bin 206 may be automatically updated based on the content being viewed by User A/User B. In one example, while User A is viewing a catalog page of the e-commerce website (e.g., a webpage of general content), the User A item bin 204 may be updated to include the most recent purchases made by any or all of User A's buddies. In another example, while User A is viewing a product page of the e-commerce website (e.g., a webpage showing specific product information), the User A item bin 204 may be updated to include items in the browsing/purchasing history of any or all of User A's buddies that are relevant to the product displayed in the product page. For instance, if User A is viewing a product page for a digital camera, the User A item bin 204 may be updated to show other digital cameras in the browsing history of User A's buddies. The relevance may be based at least in part on information describing a function, a characteristic and/or a price of the items in the browsing history of User A's buddies with respect to the content of the webpage being viewed by User A. Such content may include text, graphics, keywords, tags, or other metadata associated with the item being displayed in the webpage. For example, items in the User A item bin 204 that are relevant to the content may include items that are similar to the product displayed in the product page in function, brand name, size, performance, use, design, cost and/or other information associated with the displayed product. In another example, items in the User A item bin 204 may be relevant to the product displayed in the product page if one or more of User A's buddies has purchased one or more of the items after or in conjunction with purchasing or browsing the displayed product or shared product details with other users via a social network.

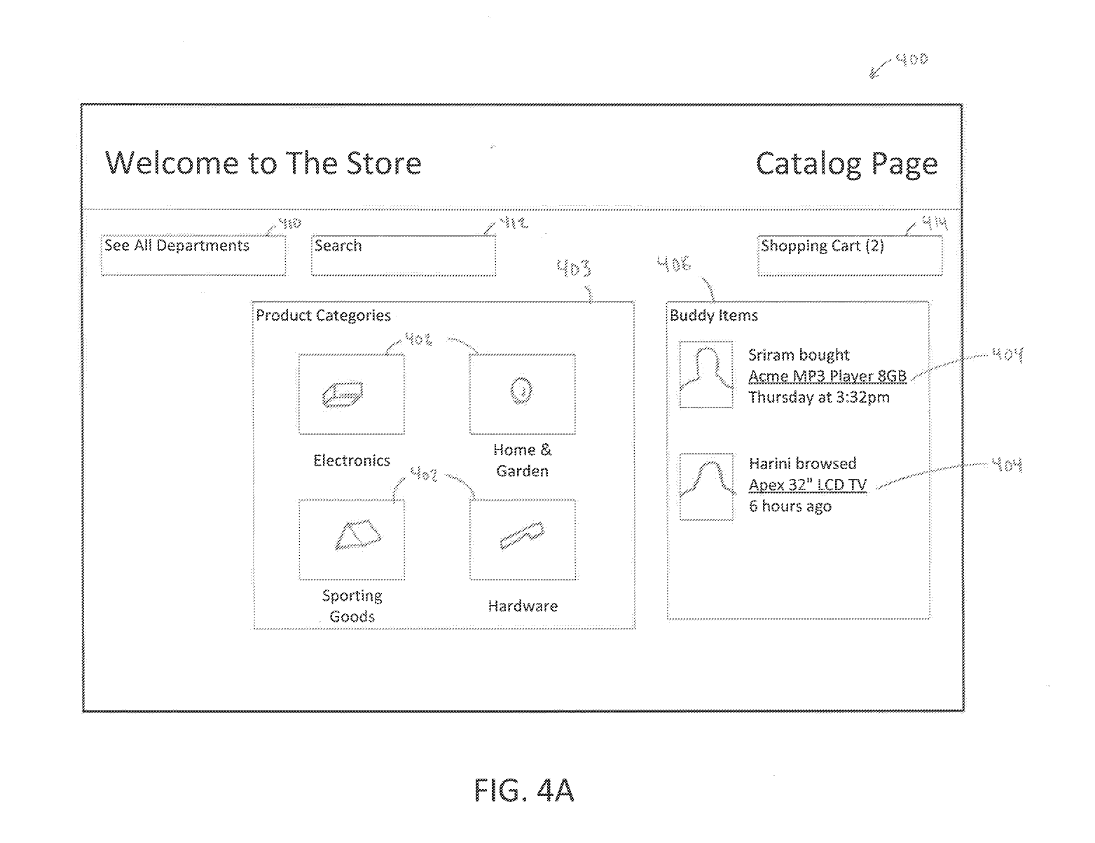

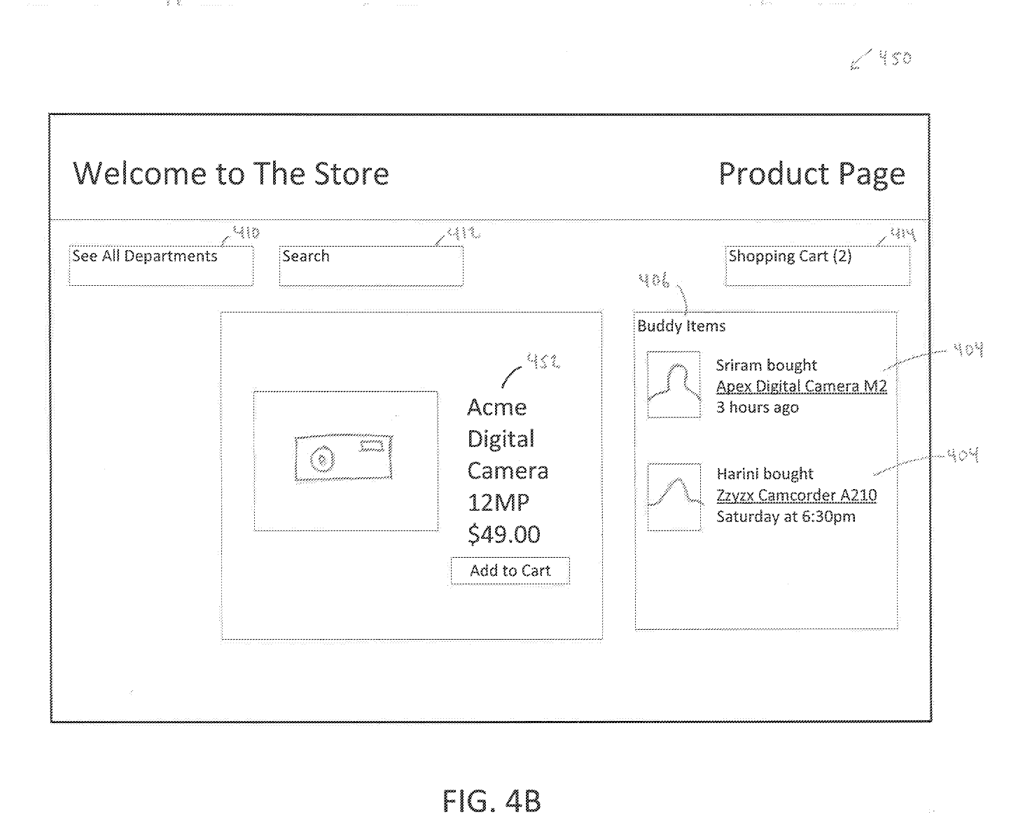

FIGS. 4A and 4B are exemplary user interfaces 400 and 450 of the e-commerce website, rendered on a client device via a browser to provide a view from the user's perspective, according to one embodiment. The user interfaces 400 and 450 may include various controls, such as “See All Departments” 410, which includes a drop-down list of all store departments from which the user may select to navigate to another page of the website associated with the selected department. Another example control includes a search box 412, in which the user may enter a text-based search query for searching the website. Yet another example control includes a shopping cart button 414, which the user may select to navigate to a virtual shopping cart containing items that the user has selected for purchase.

In one example, the user interface 400 in FIG. 4A represents an exemplary catalog page of the website in which various product categories 402 (e.g., electronics, home and garden, sporting goods, hardware, etc.) are displayed to the user in a dialog box 403 by the server 200 of FIG. 2. The user interface 400 may provide general information intended to assist the user in navigating the website. The product categories 402 may be selectable by the user within the user interface 400 to link to items in the respective product categories. For example, if the user selects one of the product categories 402, the website will update the user interface 400 to display items related to the selected product category, as will be understood by one of skill in the art.

Additionally, the user interface includes representations of one or more items 404 in the user's item bin, depicted in FIGS. 4A and 4B within a buddy items window 406. As described above, an item bin may be associated with, and personalized for, each user. Thus, for example, when a user enters the catalog page of the website, the user interface 400 includes at least one of the items previously stored in the item bin corresponding to the user (i.e., referring to FIG. 2, User A may see representations of one or more items in the User A item bin 204). In other words, the user will see, in the item bin, items from the browsing history of one or more buddies. The browsing history of the buddies may include historical browsing (e.g., items that the buddy browsed/purchased at a prior point in time) or current browsing (e.g., items that the buddy is currently browsing/purchasing). Additionally, the name of the user (buddy) may also be displayed in the item bin along with any additional information, such as the time and date of the activity obtained from the browsing/purchasing history. In one embodiment, the user may select (e.g., click on) a representation of one of the items 404 to browse and/or purchase the item.

The user interface 450 in FIG. 4B represents an exemplary product page of the website in which specific information about a particular item 452 or items can be displayed, such as the product name, price, image, etc. The user interface 450 includes representations of one or more items 404 in the user's item bin 406, except that, unlike in the user interface 400 described above with respect to FIG. 4A, the items displayed in the item bin 406 of the user interface 450 are related to the item 452 currently being displayed to the user. For example, the items in the item bin 406 may be related to the displayed item 452 by similar function (e.g., cameras, TVs, MP3 players, lawn darts, etc.), similar category (e.g., electronics, home and garden, sporting goods, hardware, etc.), similar price, etc. Thus, for example, while User A is viewing a product page for a digital camera, the item bin 406 may display a list of digital cameras browsed or purchased by one or more buddies, such as User B.

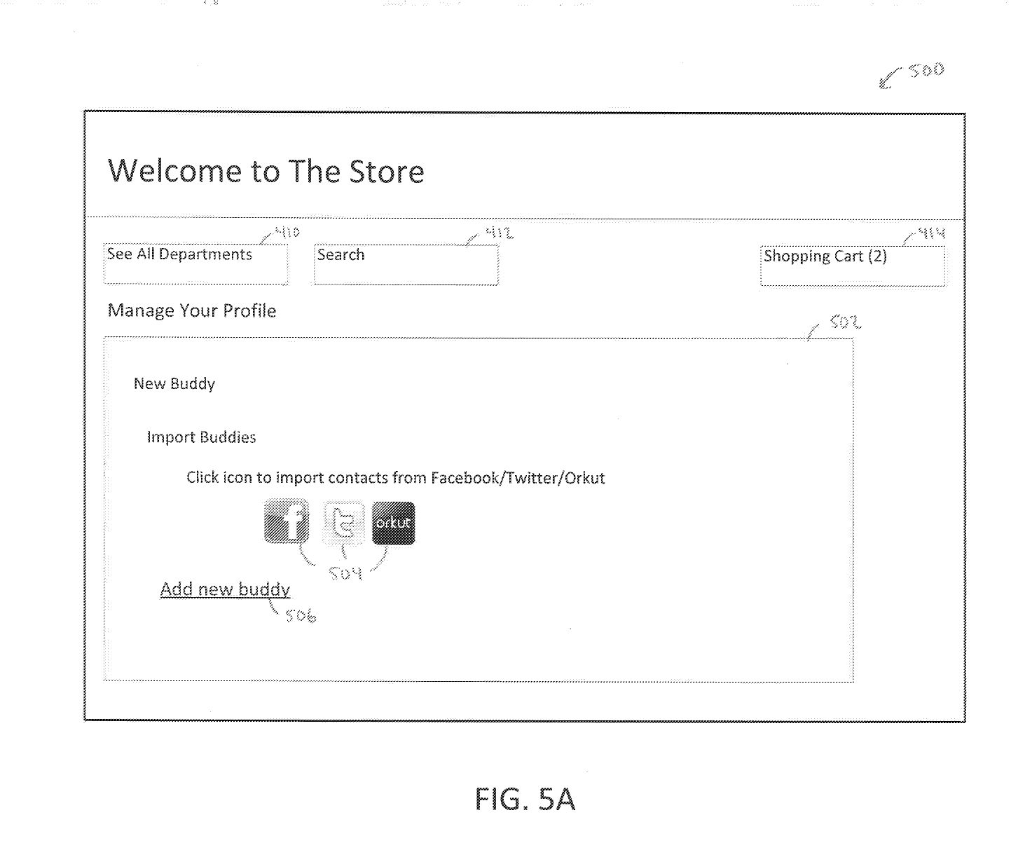

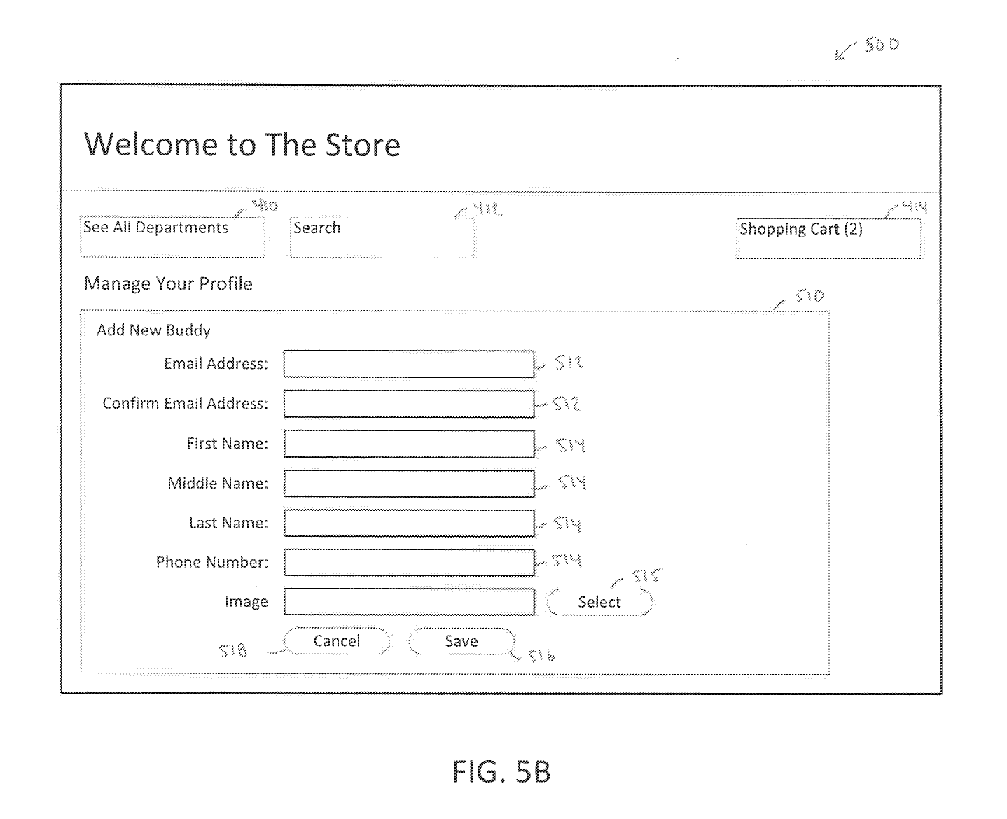

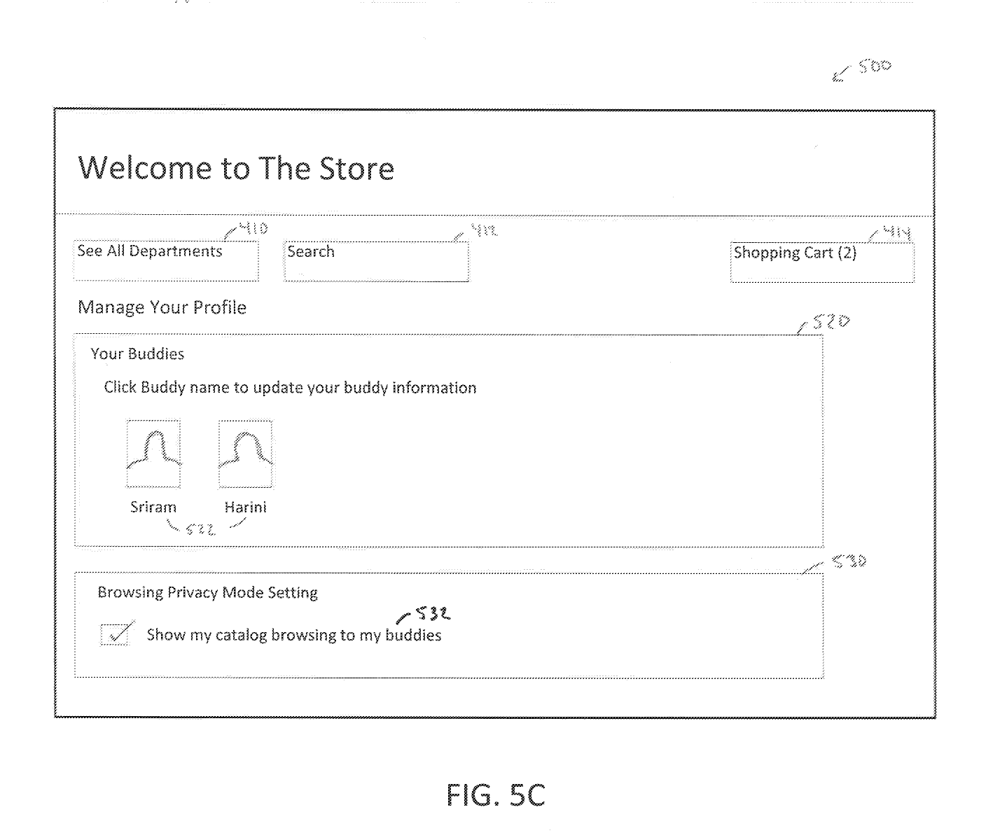

FIGS. 5A-5C show several exemplary user interfaces that may be used by a user to establish one or more connections with other users (e.g., friends or buddies) within the context of the e-commerce environment using existing social network connections, or by inviting other users to establish connections. For example, FIG. 5A includes a user interface 500 having a dialog box 502 in which a user may import contacts from one or more social networking services (e.g., Facebook®, Twitter®, Orkut®, etc.) by selecting an icon 504 representing the social networking service from which the contacts should be imported. If the user selects one of the icons 504, the e-commerce platform 100 may send a message to the respective social network service requesting to download the contact list associated with the user within the context of the social networking platform 102. The e-commerce platform 100 may receive, in response to the request, data including the contact list, which may be used to establish one or more new connections between the user and other users in the contact list within the context of the e-commerce environment 100.

Alternatively, the user may elect to create a connection by inviting another user to establish a connection using the “Add new buddy” link 506, as shown in FIG. 5A. When the “Add new buddy” link 506 is selected, the user may be presented with a different dialog box 510, as shown in FIG. 5B. The dialog box 510 may prompt the user to enter information about the person with whom the user wishes to establish a new connection, such as the person's e-mail address 512, name and phone number 514, and other contact information. The user may select the “Select” button 515, for example, to upload an image to the e-commerce platform, such as an image of the person or other image. The image may be associated with the connection such that it is displayed on other pages of the website in conjunction with information about the connection (e.g., as in the buddy items window 406 of FIGS. 4A and 4B). Upon selecting the “Save” button 516, the e-commerce platform 100 may send an invitation to the specified person using the contact information provided by the user. The e-commerce platform 100 may receive, in response to the invitation, an affirmative response from the invited person, which may be used to establish a new connection between the user and the invited person within the context of the e-commerce environment 100. The user may select the “Cancel” button 518 to exit the dialog box 510 without performing any function.

Once one or more connections (e.g., friends or buddies) have been established within the context of the e-commerce platform 100, the user may manage those connections using yet another dialog box 520, as shown in FIG. 5C. The dialog box 520 may display the names 522 of each connection that exists between the user and another person within the context of the e-commerce platform 100. The user may select one of the names 522 to edit or remove the connection.

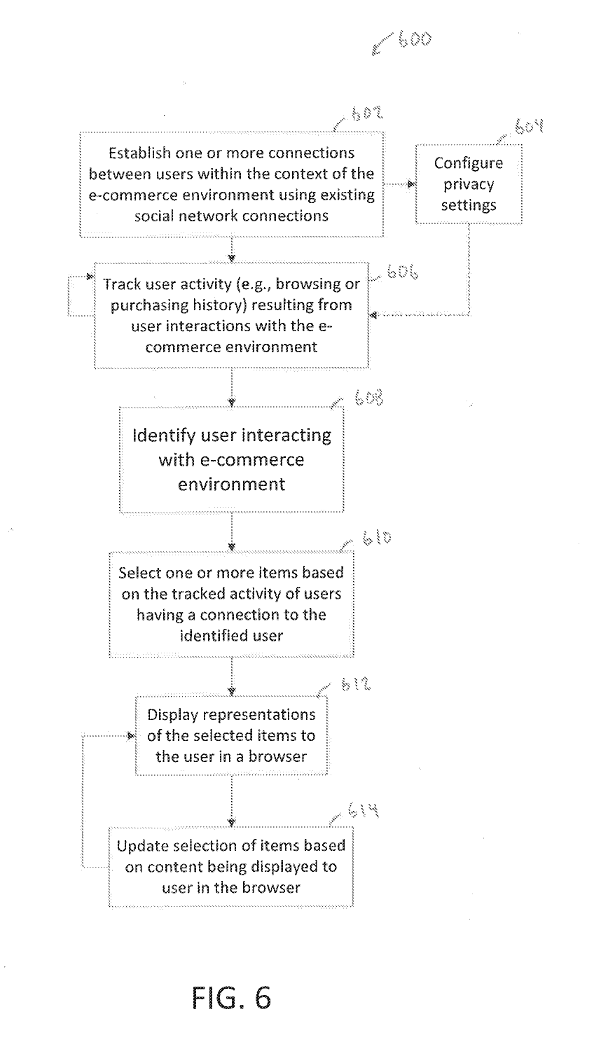

Further, the user may manage security settings using a dialog box 530, as shown in FIG. 5C and as discussed below with respect to FIG. 6. For example, the dialog box 530 may include a setting 532 that permits information related to the user's browsing or purchasing history to be displayed to other connected users or specific users, or prevents the user's browsing or purchasing history from being displayed. The setting 532 may be selected or deselected by the user within the dialog box 530.

FIG. 6 is a flow diagram showing one example of a method 600 for shopping in an electronic commerce environment, according to one embodiment. As discussed above, users who interact with the e-commerce environment may have pre-existing connections within a social network. At block 602, a first user may establish a connection with a second user in the e-commerce environment based on one or more of the pre-existing connections. For example, the first user may import connections (e.g., a contact list, a friend list, a distribution list, etc.) from a social networking website into the e-commerce environment. The imported connections may then be stored in association with the first user's online account at, e.g., an e-commerce website. In another example, the first user may, via the e-commerce environment, send an invitation to the second user inviting the second user to establish a connection to the first user in the e-commerce environment. The invitation may be sent, for example, by e-mail or instant messaging, or by using a messaging feature supported by the social networking platform. If the second user responds affirmatively to the invitation, the connection may be established. The e-commerce environment may provide a user interface to the first user's browser that enables the first user to import connections and/or invite the second user to become a connection.

At block 604, the first user may configure privacy settings corresponding to information associated with the first user's activities in the e-commerce environment. For example, the privacy settings may include a setting that permits information related to the first user's browsing or purchasing history to be displayed to other connected users or specific users, or prevents same. The e-commerce environment may be configured to honor the selected privacy settings accordingly, for example, by not performing one or more steps of the method 600. In another example, the second user may configure privacy settings in a similar manner to the first user.

At block 606, the e-commerce environment tracks the activity of one or more users, including potentially the first and second users, as each user interacts with the e-commerce environment. Such activities may include, for example, the browsing and/or purchasing history of each user, such as described above with respect to FIG. 2. The tracking activity may occur once, periodically, or continuously even while other steps in the method 600 are being performed, since it cannot always be predicted when any given user will choose to interact with the e-commerce environment.

At block 608, the first user interacting with the e-commerce environment is identified. Such identification may include, for example, by comparing a username or account number against a database in which user identification information is stored. At block 610, one or more items for sale in the e-commerce environment are selected (e.g., from the item catalog 202 of FIG. 2) based on the tracked activity of the second user (or another user with whom the first user has a connection to in the e-commerce environment).

At block 612, representations of the items selected at block 610 are displayed to the first user via a browser, for example, in the item bins 406 described above with respect to FIGS. 4A and 4B. As the first user continues to interact with the e-commerce environment, the content being displayed to the first user may change. For example, the user may begin browsing in a catalog page of the e-commerce website, and then navigate to a product page of the website. At block 614, as the browsed content changes, the selection of items that occurred at block 610 may be updated to reflect the changed content. For example, if the first user is viewing a digital camera, the selected items may be updated to only include other digital cameras for sale in the e-commerce environment, or digital cameras within a price range that is higher or lower than the price of the digital camera being viewed by the first user. In particular, the selection may include any digital cameras that were browsed or purchased by the second user (or another user with whom the first user has a connection to in the e-commerce environment). As the selection of items is updated, the method 600 may return to block 612 to display representations of the updated selection of items to the first user via the browser.

### Exemplary Computing Devices

FIG. 7 is a block diagram of an exemplary computing device 700 that may be used in to perform any of the methods provided by exemplary embodiments. The computing device 700 includes one or more non-transitory computer-readable media for storing one or more computer-executable instructions or software for implementing exemplary embodiments. The non-transitory computer-readable media may include, but are not limited to, one or more types of hardware memory, non-transitory tangible media, and the like. For example, memory 706 included in the computing device 700 may store computer-executable instructions or software for implementing exemplary embodiments. The computing device 700 also includes processor 702 and, optionally, one or more additional processor(s) 702′ for executing computer-executable instructions or software stored in the memory 706, and other programs for controlling system hardware. Processor 702 and optional processor(s) 702′ may each be a single core processor or multiple core (704 and 704′) processor.

Virtualization may be employed in the computing device 700 so that infrastructure and resources in the computing device may be shared dynamically. A virtual machine 714 may be provided to handle a process running on multiple processors so that the process appears to be using only one computing resource rather than multiple computing resources. Multiple virtual machines may also be used with one processor.

Memory 706 may include a computer system memory or random access memory, such as DRAM, SRAM, EDO RAM, and the like. Memory 706 may include other types of memory as well, or combinations thereof.

A user may interact with the computing device 700 through a visual display device 718, such as a computer monitor, which may display one or more user interfaces 720 or any other interface. In exemplary embodiments, the display device 718 may output or display one or more web pages, such as those represented by the user interfaces 400, 450 and 500 of FIGS. 4A, 4B, 5A, 5B and 5C. The display device 718 may also display other aspects, elements and/or information or data associated with exemplary embodiments.

The computing device 700 may include other I/O devices such a keyboard or a multi-point touch interface 708 and a pointing device 710, for example a mouse, for receiving input from a user. The keyboard 708 and the pointing device 710 may be connected to the visual display device 718. The computing device 700 may include other suitable conventional I/O peripherals. The computing device 700 may also include a storage device 724, such as a hard-drive, CD-ROM, or other computer readable media, for storing data and computer-readable instructions or software that implement exemplary embodiments. For example, at least some of the data and/or software associated with the e-commerce platform 100 of FIG. 1 may be stored on the storage device 724.

The computing device 700 may include a network interface 712 configured to interface via one or more network devices 722 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. The network interface 712 may include a built-in network adapter, network interface card, PCMCIA network card, card bus network adapter, wireless network adapter, USB network adapter, modem or any other device suitable for interfacing the computing device 700 to any type of network capable of communication and performing the operations described herein. Moreover, the computing device 700 may be any computer system, such as a workstation, desktop computer, server, laptop, handheld computer or other form of computing or telecommunications device that is capable of communication and that has sufficient processor power and memory capacity to perform the operations described herein.

The computing device 700 may run any operating system 716, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, any operating systems for mobile computing devices, or any other operating system capable of running on the computing device and performing the operations described herein. The operating system 716 may be run in native mode or emulated mode. In an exemplary embodiment, the operating system 716 may be run on one or more cloud machine instances.

The computing device 700 may include a database 726 for storing, for example, tracked user activity, browsing/purchasing history, item information, lists, tables, files, or other data used to facilitate functions described herein of the e-commerce platform 100 and/or social network platform 102.

### Exemplary Network Environments

FIG. 8 is an exemplary network environment 800 suitable for a distributed implementation of exemplary embodiments. The network environment 800 may include one or more servers 802 and 804 coupled to one or more clients 806 and 808 and a database 820 via a communication network 810. For example, server 802 may host the e-commerce platform 100 of FIG. 1 and server 804 may host the social networking platform 102 of FIG. 1. Further, the client 806, 808 may host a browser 812, 814 for accessing web pages generated by the servers 802, 804. The network interface 712 and the network device 722 of the computing device 700 of FIG. 7 enable the servers 802 and 804 to communicate with the clients 806 and 808 and the database 820 via the communication network 810. The communication network 810 may include, but is not limited to, the Internet, an intranet, a LAN (Local Area Network), a WAN (Wide Area Network), a MAN (Metropolitan Area Network), a wireless network, an optical network, and the like. The communication facilities provided by the communication network 810 are capable of supporting distributed implementations of exemplary embodiments.

Having thus described several exemplary embodiments of the invention, it is to be appreciated various alterations, modifications, and improvements will readily occur to those skilled in the art. Such alterations, modifications, and improvements are intended to be part of this disclosure, and are intended to be within the scope of the invention. Accordingly, the foregoing description and drawings are by way of example only.

What is claimed is:

1. A computer-implemented method for shopping in an electronic commerce environment via a data communication network, the method comprising:
identifying, by a server, a first user who is interacting with the electronic commerce environment via a browser;
selecting, by the server, items for sale in the electronic commerce environment based on a browsing history of a second user associated with the first user via a social network connection; and
displaying a representation of the selected items to the first user via the browser,
wherein the browsing history of the second user includes items viewed and/or purchased by the second user.

2. The method of claim 1, further comprising updating the selection of items to include items relevant to content being displayed to the first user via the browser.

3. The method of claim 2, wherein the relevance is based at least in part on information describing a function, a characteristic and/or a price of the items with respect to the content.

4. The method of claim 1, further comprising enabling the first user to view additional information about the item and/or purchase the item in the electronic commerce environment by selecting the representation of the item using the browser.

5. The method of claim 1, further comprising tracking, by the server, user activity of the second user resulting from an interaction with the electronic commerce environment by the second user, wherein the browsing history of the second user is based at least in part on the user activity of the second user.

6. The method of claim 1, further comprising enabling the first user to become associated with the second user by importing the social network connection into the electronic commerce environment.

7. The method of claim 1, further comprising enabling the first user to become associated with the second user by sending an invitation to the second user via the data communication network and receiving an affirmative response to the invitation from the second user.

8. The method of claim 1, further comprising enabling the second user to select privacy settings associated with the browsing history of the second user, wherein the representation of the selected items is displayed to the first user according to the privacy settings.

9. The method of claim 8, wherein the privacy settings include a setting that, when selected by the second user, prevents the browser from displaying the representation of the at least one suggested item to the second user.

10. A system for shopping in an electronic commerce environment, the system comprising:
a server having a processor and a memory coupled together, the memory including instructions that when executed by the processor cause the server to:
identify a first user who is interacting with the electronic commerce environment via a browser;
select items for sale in the electronic commerce environment based on a browsing history of a second user associated with the first user via a social network connection; and
display a representation of the selected items to the first user via the browser,
wherein the browsing history of the second user includes items viewed and/or purchased by the second user.

11. The system of claim 10, wherein the memory further includes instructions that when executed by the processor cause the server to update the selection of items to include items relevant to content being displayed to the first user via the browser.

12. The system of claim 11, wherein the relevance is based at least in part on information describing a function, a characteristic and/or a price of the items with respect to the content.

13. The system of claim 10, wherein the memory further includes instructions that when executed by the processor cause the server to enable the first user to view additional information about the item and/or purchase the item in the electronic commerce environment by selecting the representation of the item using the browser.

14. The system of claim 10, wherein the memory further includes instructions that when executed by the processor cause the server to track user activity of the second user resulting from an interaction with the electronic commerce environment by the second user, wherein the browsing history of the second user is based at least in part on the user activity of the second user.

15. The system of claim 10, wherein the memory further includes instructions that when executed by the processor cause the server to enable the first user to become associated with the second user by importing the social network connection into the electronic commerce environment.

16. The system of claim 10, wherein the memory further includes instructions that when executed by the processor cause the server to enable the first user to become associated with the second user by sending an invitation to the second user via the data communication network and receiving an affirmative response to the invitation from the second user.

17. The system of claim 10, wherein the memory further includes instructions that when executed by the processor cause the server to enable the second user to select privacy settings associated with the browsing history of the second user, wherein the representation of the selected items is displayed to the first user according to the privacy settings.

18. A non-transitory computer-readable medium having stored thereon computer-executable instructions that when executed by a computer cause the computer to:
identify a first user who is interacting with the electronic commerce environment via a browser;
select items for sale in the electronic commerce environment based on a browsing history of a second user associated with the first user via a social network connection; and
display a representation of the selected items to the first user via the browser,
wherein the browsing history of the second user includes items viewed and/or purchased by the second user.

19. The non-transitory computer-readable medium of claim 18, further including instructions that when executed by the computer cause the computer to update the selection of items to include items relevant to content being displayed to the first user via the browser.

20. The non-transitory computer-readable medium of claim 18, further including instructions that when executed by the computer cause the computer to enable the first user to become associated with the second user by importing the social network connection into the electronic commerce environment.
